(19) United States
(12) Patent Application Publication
(10) Pub. No.: US 2014/0052634 A1
(43) Pub. Date: Feb. 20, 2014

(54) MERGING BALANCES OF PAYMENT CARDS

(71) Applicants: Joshua Baron, Wildwood, MO (US); Aimee Musil, Dardenne Prairie, MO (US); Prashant Sharma, Ballwin, MO (US)

(72) Inventors: Joshua Baron, Wildwood, MO (US); Aimee Musil, Dardenne Prairie, MO (US); Prashant Sharma, Ballwin, MO (US)

(21) Appl. No.: 13/587,660

(22) Filed: Aug. 16, 2012

(51) Int. Cl. G06Q 20/22

(52) U.S. Cl. CPC G06Q 20/227
USPC 705/44; 705/39

(57) ABSTRACT

A system, method, and computer-readable storage medium configured to merge the balances of payment cards into a fused card.

### BACKGROUND

1. Field of the Invention

Aspects of the disclosure relate in general to financial services. Aspects include an apparatus, system, method and computer-readable storage medium to merge balances of payment cards.

2. Description of the Related Art

payment card is a card electronically linked to an account or accounts belonging to a cardholder. These accounts may be deposit accounts or loan or credit accounts. There are a number of payment cards including credit cards, debit cards, charge cards, and prepaid cards.

A credit card is a payment card entitling its holder to a line of credit from which the cardholder can borrow from the card issuer.

A debit card (also known as a “bank card” or “check card”) is functionally an electronic check, as funds are withdrawn directly from a bank account associated with the card.

A charge card is similar to a credit card, except that the contract with the card issuer requires that the cardholder must each month pay charges made to it in full—there is no “minimum payment” other than the full amount owed.

A prepaid card is a restricted monetary equivalent or scrip that is issued by retailers or banks to be used as an alternative to a non-monetary gift. A prepaid card may also be referred to as a “gift card” or “stored value card.” In some instances, the card may be assigned to a cardholder or anonymous.

Unlike closed-system prepaid cards (such as transit system cards), open-system prepaid cards are used anywhere credit or debit cards with the same payment brand mark may be used. Prepaid cards are similar to a debit card except that they do not require a checking account.

Typically, a payment card's value or “balance” is not physically stored on the card. Instead, a card number uniquely identifies a record in a central database at the card issuer, where the balance is recorded. The unique number is commonly referred to as a Primary Account Number (PAN). The Primary Account Number is often embossed or imprinted on the prepaid card, and a magnetic stripe on the back of the card contains the data in-machine readable format. The data can vary, but the most common include:

Name of card holder, Account number, Expiration date, and a security code (such as a Card Verification Value or “CVV” code).

Payment cards are typically endorsed by an electronic network, such as one operated by the assignee of the present invention, MasterCard International Incorporated.

An example payment card 100 is depicted in FIG. 15. In this example, the card is a prepaid card.

Prepaid cards rank as the second-most given gift by consumers in the United States (2006) and the most-wanted gift by women, and the third-most wanted by males. In Canada, $1.8 billion were spent on prepaid cards and in the UK, it is estimated to reach £3 billion for 2009 whereas in the United States, about US$80 billion were paid for prepaid cards in 2006. The recipients of a prepaid card can use it at their discretion within the restrictions set by the issuing agency.

### SUMMARY

Embodiments include a system, device, method and computer-readable medium to merge the balances of payment cards into a fused card. A user is authenticated. A plurality of payment cards associated with the user is retrieved from a database. A card balance of each of the plurality of payment cards is obtained, and presented to the user. A selection of one of a plurality of payment cards is made, resulting in a first selected card, and remaining cards. A selection of at least one of the remaining cards is made, resulting in a second selection of cards. The selection choices are received via a network interface. A purchase transaction of an amount from the second selection of cards is generated, and a payment transaction of the amount is generated to the first selected card, resulting in the fused card.

### BRIEF DESCRIPTION OF THE DRAWINGS

FIG. 1 illustrates an embodiment of a system configured to merge balances of payment cards.

FIG. 2 depicts an apparatus embodiment configured to merge balances of payment cards.

FIG. 3 flowcharts a method embodiment in the balance of a payment card is merged with that of another card.

FIG. 4 is a sequence diagram of an embodiment to merge balances of payment cards.

FIG. 5 is a sequence diagram of an embodiment to check the balance of a payment card.

FIG. 6 illustrates an example of user authentication on a mobile phone.

FIG. 7 displays the presentation of payment card balances on a mobile phone embodiment.

FIG. 8 shows an embodiment prompting a user to select one payment card to be a fused card on a mobile phone.

FIG. 9 illustrates prompting a user to select one or more payment card to be merged with a fused card.

FIG. 10 displays a mobile phone embodiment of verifying a user's permission to merge payment cards.

FIG. 11 illustrates a merging balances of payment cards on a mobile phone.

FIGS. 12-14 illustrate a mobile phone embodiment of entering payment cards into a device configured to merge balances of payment cards.

FIG. 15 illustrates an example payment card that may be used with an embodiment.

### DETAILED DESCRIPTION

One aspect of the disclosure includes the realization that many prepaid cards with low balances are never used. Embodiments enable users to merge the balances of payment cards. By merging the balances of multiple payment cards, consumers are more likely to spend and use their prepaid card and other payment card balances.

In another aspect of the disclosure, embodiments facilitate donations of unused payment card balances to charities.

These and other benefits may be apparent in hindsight to one of ordinary skill in the art.

Embodiments of the present disclosure include a system, method, and computer-readable storage medium configured to merge the balances of payment cards into a “fused” card.

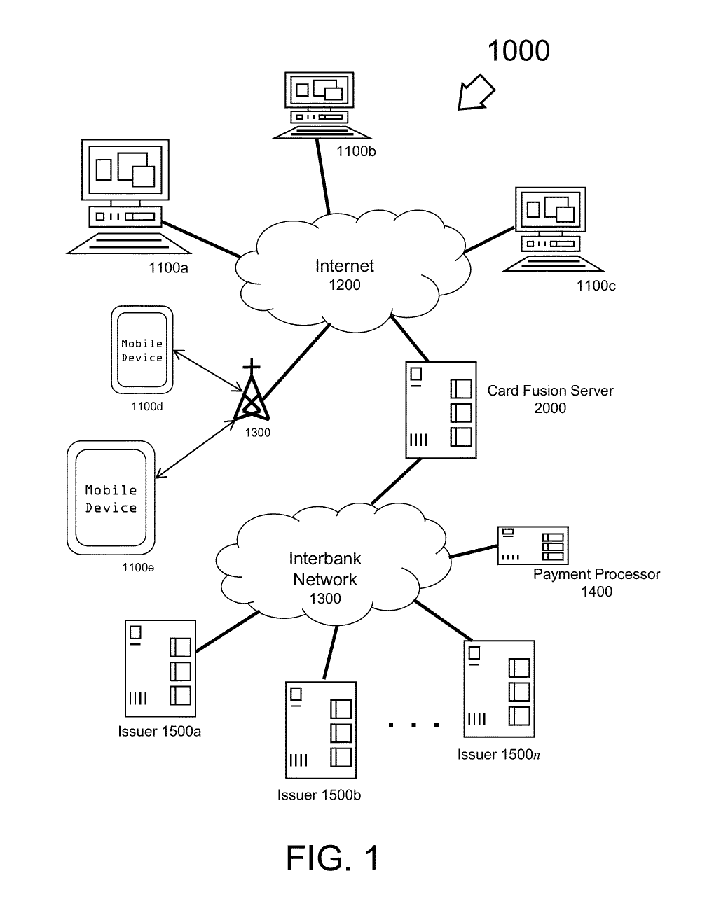

FIG. 1 illustrates an embodiment of a system 1000 configured to merge balances of payment cards 100, constructed and operative in accordance with an embodiment of the present disclosure. System 1000 includes consumers using a plurality of computing devices 1100a-e to connect to a card fusion server 2000 via a data network 1200, such as the Internet. Details and example uses of card fusion server 2000 are discussed below.

In some embodiments, consumers may use mobile computing devices 1100d-e and connect to card fusion server 2000 via a wireless data network 1300 capable of connecting to the Internet. It is understood that wireless data network 1300 may be a wireless data provider such as a cellular telephone network, wireless local area network (WLAN or “WiFi networks”), satellite data networks, and the like. Mobile computing devices 1100 include mobile devices such as mobile telephones, tablet computers, laptop computers, “ultra books” or other portable computing device known in the art capable of communicating to card fusion server 2000.

As shown in FIG. 1, card fusion server 2000 may be connected to payment processor 1400 and issuers 1500a-n via an interbank network.

Payment processor 1400 is a payment network capable of processing payments electronically. Example payment processors 1400 include MasterCard International Incorporated.

Issuers 1500a-n include any banks and other entities that issue payment cards 100.

An interbank network 1300 is a computer network that connects different banking institutions. For example, an Automated Teller Machine (ATM) consortium network is an interbank network.

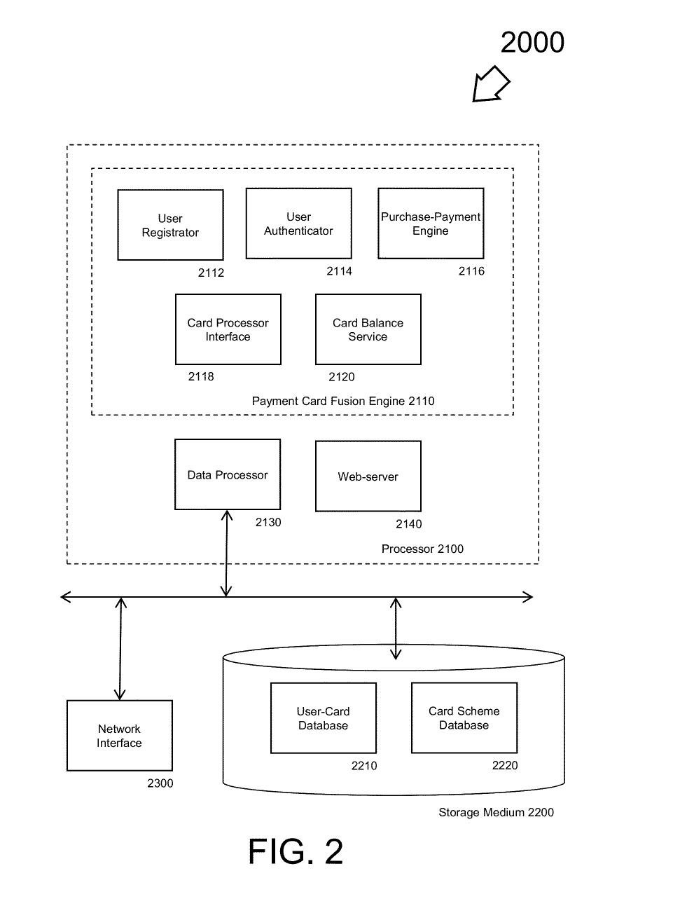

Embodiments will now be disclosed with reference to a block diagram of an exemplary card fusion server 2000 of FIG. 2, constructed and operative in accordance with an embodiment of the present disclosure. Card fusion server 2000 is configured to merge balances of payment cards 100.

Card fusion server 2000 may run a multi-tasking operating system (OS) and include at least one processor or central processing unit (CPU) 2100, a non-transitory computer-readable storage medium 2200, and a network interface 2300.

Processor 2100 may be any central processing unit, microprocessor, micro-controller, computational device or circuit known in the art.

It is well understood by those in the art, that the elements of FIG. 2 may be implemented as hardware, firmware, or as software instructions and data encoded on a non-transitory computer-readable storage medium 2200.

As shown in FIG. 2, processor 2100 is functionally comprised of a payment card fusion engine 2110, a web-server 2140, and a data processor 2130.

Payment card fusion engine 2110 may further comprise: user registrator 2112, user authenticator 2114, purchase-payment engine 2116, card processor interface 2118, and card balance service 2120. User registrator 2112 enables consumers to register and input their associated payment card information into a user-card database 2210. User authenticator 2114 is an interface that allows users to authenticate themselves with payment card fusion engine 2110. Purchase-payment engine 2116 performs payment and purchase transactions to payment cards 100. Card processor interface 2118 enables the payment card fusion engine 2110 to communicate with payment processor 1400. Card balance service 2120 enables the payment card fusion engine 2110 to determine the balance of a payment card 100. In some embodiments, card balance service 2120 may exist at payment processor 1400 or issuer 1500. These structures may be implemented as hardware, firmware, or software encoded on a computer readable medium, such as storage media 2200. Further details of these components are described with their relation to method embodiments below.

Data processor 2130 interfaces with storage media 2200 and network interface 2300. The data processor 2130 enables processor 2100 to locate data on, read data from, and write data to, these components.

Web-server 2140 is any computing device configured to deliver web pages or other content across the Internet 1200 via network interface 2300; user devices 1100 may communicate with a payment card fusion engine 2110 via the World-Wide-Web protocol and web-server 2140.

Network interface 2300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 2300 allows card fusion server 2000 to communicate with internet 1200, consumer 1100, consumers using mobile payment devices 1100d-e, interbank network 1300, payment processor 1400, and issuers 1500a-n.

Computer-readable storage media 2200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. Significantly, computer-readable storage media 2200 may be remotely located from processor 2100, and be connected to processor 2100 via a network such as a local area network (LAN), a wide area network (WAN), or the Internet 1200.

In addition, as shown in FIG. 2, storage media 2200 may also contain a user-card database 2210, and a card scheme database 2220. User-card database 2210 is configured to store information associating users with payment cards. Users may be individuals, businesses, charities, or other entities. For individual user accounts, users may be associated with one or more payment cards. For charities and their associated payment cards, the payment cards 100 may accept donations from multiple individual users through the payment card fusion process. Card scheme database 2220 facilitates the look-up of issuers 1500 as described below.

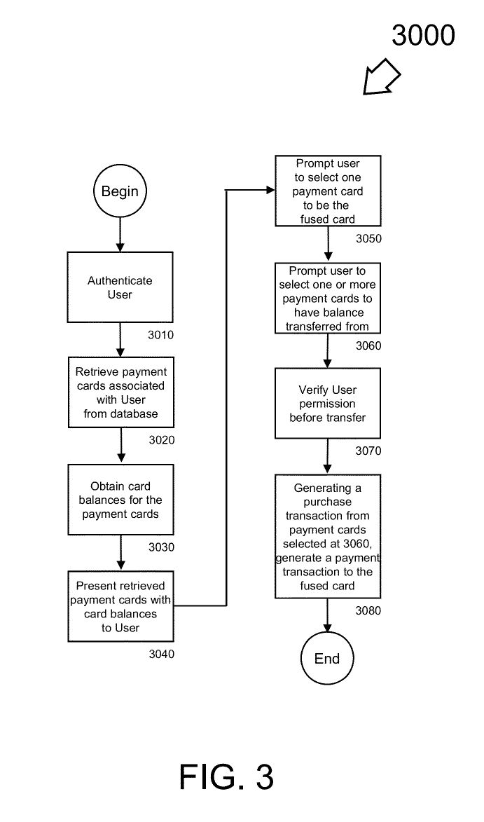

It is understood by those familiar with the art that one or more of these databases 2210-2220 may be combined in a myriad of combinations. The function of these structures may best be understood with respect to the flowcharts of FIGS. 3-14, as described below.

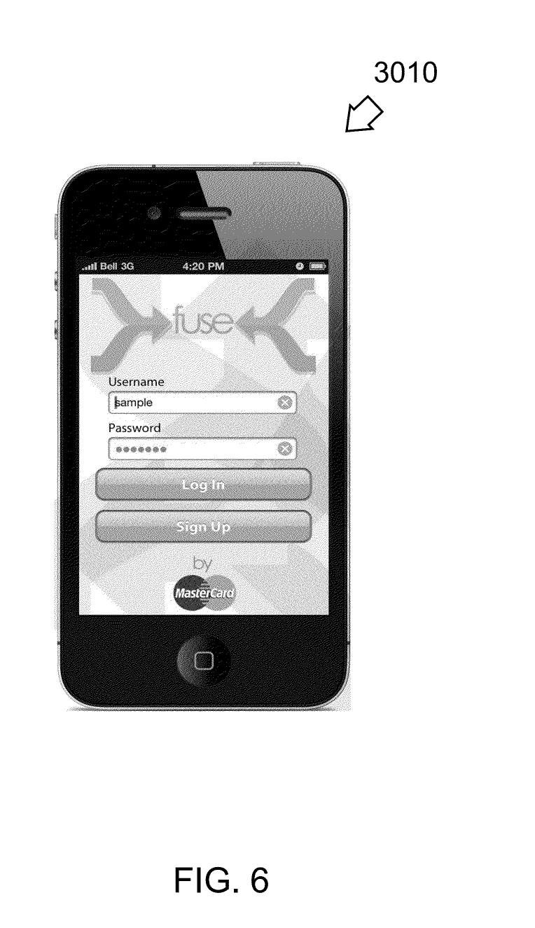

We now turn our attention to method or process embodiments of the present disclosure, FIGS. 3-14. It is understood by those known in the art that instructions for such method embodiments may be stored on their respective computer-readable memory and executed by their respective processors. Moreover, mobile phone embodiments are depicted at FIGS. 6-14, but it is understood by those skilled in the art that other equivalent implementations can exist without departing from the spirit or claims of the invention. For example, the computing device described and depicted herein may also be stationary device, such as a desktop computer.

It is further understood that embodiments of the present disclosure may be applied to a variety of payment card types, including credit, debit, charge, prepaid cards and electronic wallets (subject to any applicable financial regulatory restrictions and requirements). An electronic wallet is a program or service where users can store and control their online shopping information, like logins, passwords, shipping address and payment card details, in one central place.

Some embodiments may be restricted to either prepaid cards or debit cards. Other embodiments allow fusing of card balances from one type of payment card to another; for example, a prepaid card balance may be fused to a credit card or debit card (subject to any applicable financial regulatory restrictions and requirements.

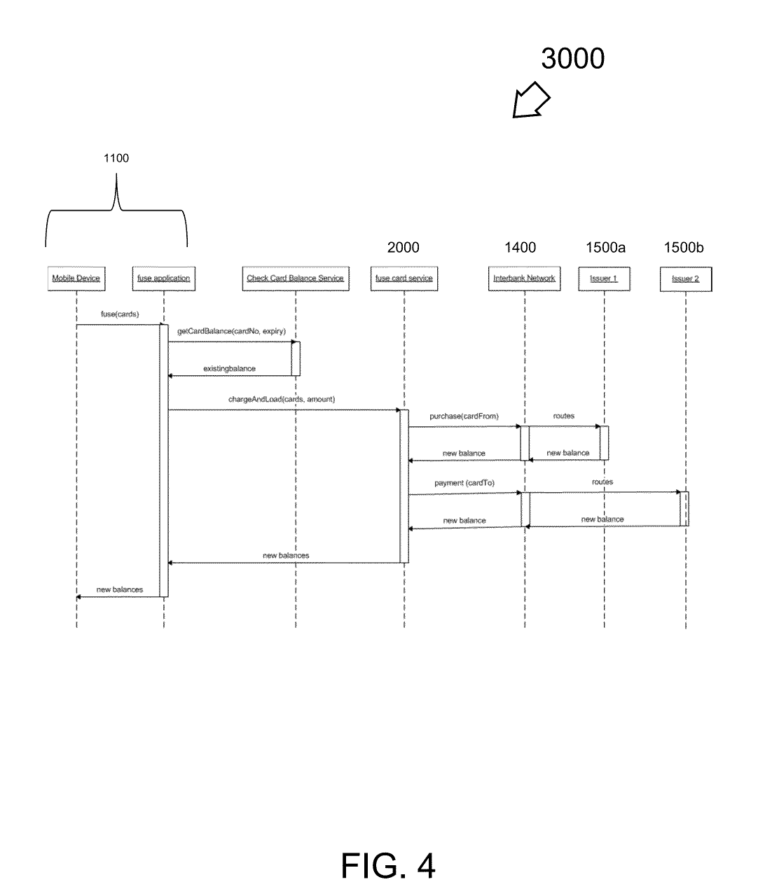

FIG. 3 flowcharts a method 3000 in which the balance of a payment card is merged with that of another payment card by payment card fusion server 2000, constructed and operative in accordance with an embodiment of the present disclosure. An example sequence diagram of method 3000 is also depicted at FIG. 4, constructed and operative in accordance with an embodiment of the present disclosure.

At block 3010, user authenticator 2114 receives information from user 1100 to authenticate the user against data stored in the user-card database 2210. Embodiments may authenticate users using any method known in the art including, but not limited to: passwords, cardkeys, optical recognition, fingerprint identification, and facial recognition. An example mobile phone embodiment of the user authentication is depicted at FIG. 6.

Payment card fusion engine 2110 retrieves the payment card data that is associated with the user from the user-card database 2210, block 3020. The payment card data includes a unique identifier such as a Primary Account Number.

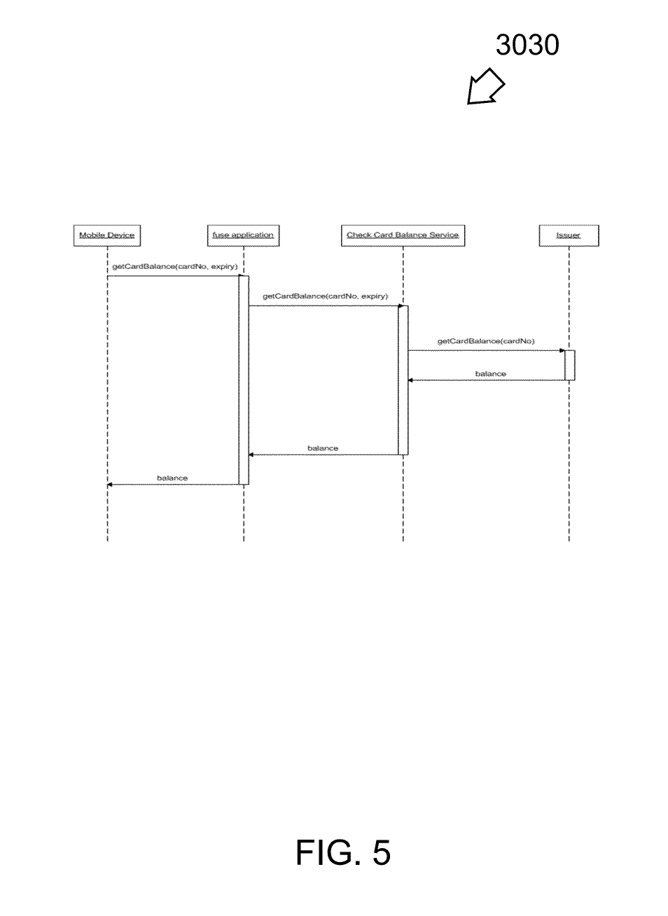

For each payment card associated with the user, payment card fusion engine 2110 obtains the card balance, block 3030. Card balance service 2120 is utilize identifies the issuer of the payment card by examining the Primary Account Number. The first six digits of a Primary Account Number are referred to as an Issuer Identification Number (IIN), and identify the institution that issued the payment card 100. Card balance service 2120 compares the payment card's Issuer Identification Number with entries in the card scheme database 2220 to identify the issuer 1500. The card balance service 2120 can then contact the issuer 1500 to obtain the card balance. A sequence diagram showing an example implementation of balance retrieval process 3030 is shown at FIG. 5, constructed and operative in accordance with an embodiment of the present disclosure.

Generally, each payment card 100 is associated with a single user 1100. However, in some embodiments, a payment card 100 may be associated with multiple users, for example a gift registry.

In one embodiment, a payment card may be associated with a user that is a charitable entity (e.g. the American Cancer Society) or a sponsor for a charitable activity/cause (e.g. “Sponsor James' Marathon Run for the American Humane Society”) 1100a. In such an embodiment, donations from multiple users 1100b-e, may be transferred from payment cards to a card owned by the charitable entity or cause 1100a. In such cards, users may only transfer balances to the charity payment card, i.e. users may not transfer funds from the charity payment card.

In one charity payment card embodiment, a user is given a receipt for balances transferred to charity payment cards.

In another charity payment card embodiment, a user may be presented a charity payment card (or multiple charity payment cards) as a “donate” or “transfer to” option even if the user was not previously associated with the charity.

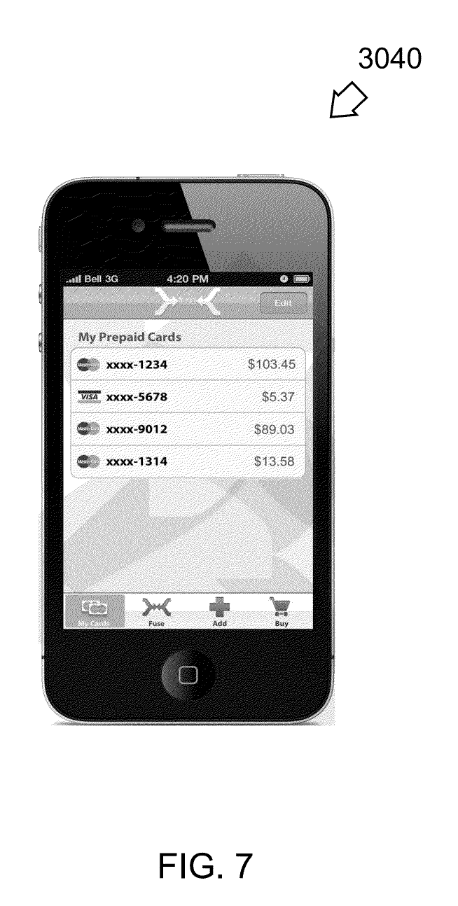

The retrieved payment cards 1500 and their balances are presented to the user, block 3040. An example mobile phone embodiment of the presentation is depicted at FIG. 7, constructed and operative in accordance with an embodiment of the present disclosure.

In a charity payment card embodiment, the balance of the charity payment card may not be presented to the user.

At block 3050, the user is prompted to select one of their associated payment cards to be the fused card. The fused card is the payment card in which the card balances will be merged into.

In some embodiments, process 3000 offers users the ability to create a new prepaid card to be the fused card.

In other embodiments, in the event of an associated payment card is a non-reloadable prepaid card, users may not be allowed to select the non-preloadable prepaid card as the fused card. Similarly, in yet other embodiments, when the selected payment card is a non-reloadable prepaid card, the user is prompted to select another card.

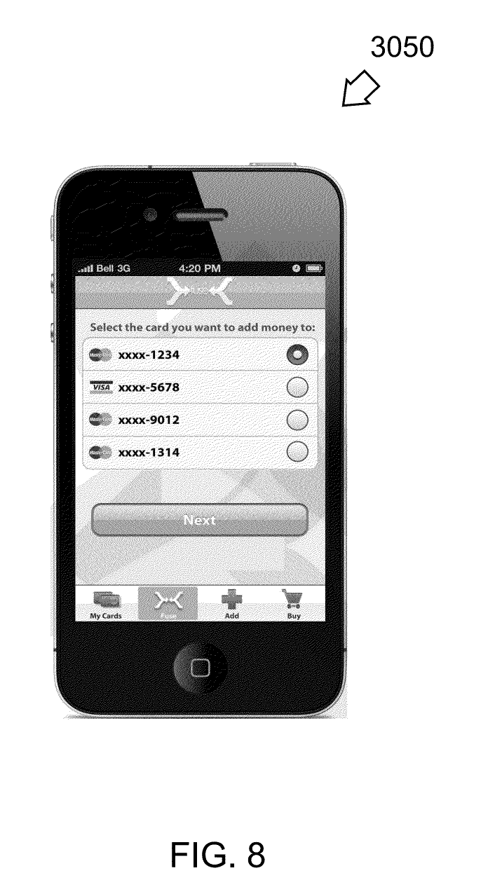

An example mobile phone embodiment of the fused card selection is depicted at FIG. 8, constructed and operative in accordance with an embodiment of the present disclosure.

In one embodiment, a user is not prompted to select a payment card, but instead a charitable cause or activity is presented. In such an embodiment, payment card balances may be fused into a charitable payment card, a charitable savings account or a charitable checking account.

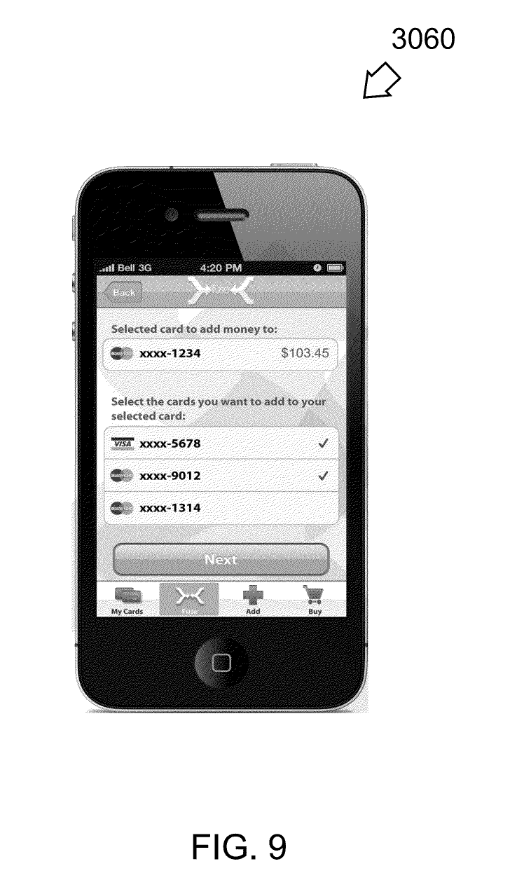

The user may then be prompted to select at least one of the associated cards to merge into the fused card, block 3060. An example mobile phone embodiment of the associated card selection is depicted at FIG. 9, constructed and operative in accordance with an embodiment of the present disclosure.

It is understood by one skilled in the art that the order of the selections performed at blocks 3050 and 3060 is not significant. One of ordinary skill in the art also understands that the selection process may occur in a number of different ways. For example, all the payment cards to be merged could be selected initially, and then the fused card may be selected.

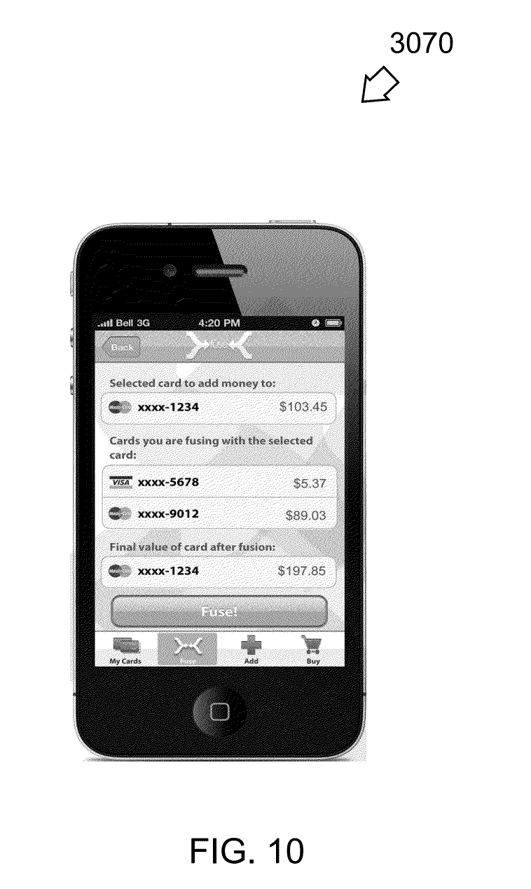

Before the balances of the payment cards are merged into the fused card, user 1100 may be prompted to verify the desired transaction, block 3070. FIG. 10 displays a mobile phone embodiment of verifying a user's permission to merge payment cards 100, constructed and operative in accordance with an embodiment of the present disclosure. In the embodiment depicted, the entire balance of the payment cards is merged into the fused card. However, this may not always be the case.

In one embodiment, users may select a subset of the payment card balance to be merged into the fused card. Using the payment cards depicted in FIG. 10 as an example, a user may decide to transfer all $5.37 of the payment card ending in 5678, and an amount less than 589.03 of the MasterCard® payment card ending in 9012 to the MasterCard® payment card ending in 1234.

In yet another embodiment, users may be restricted in the amount they can merge into the fused card.

In yet another embodiment, a bonus amount may be merged into a fused card. Such a bonus amount can be the result of a promotion, for example.

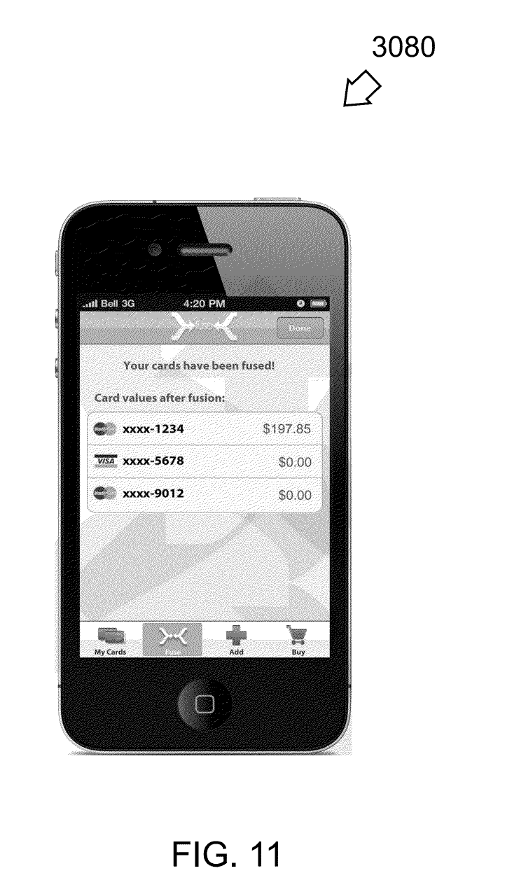

At block 3080, purchase-payment engine 2116 generates a purchase transaction to take the balance(s) from the payment cards selected at block 3060, and generates a payment transaction to apply these funds to the balance of the fused card selected at block 3050. FIG. 11 illustrates merging balances of payment cards 100 on a mobile phone, constructed and operative in accordance with an embodiment of the present disclosure.

As mentioned above, in the example shown the entire balance of the payment cards is merged into the fused card. While most transactions occurring at block 3080 generate payment transaction of the same amount as the purchase transaction, there are some embodiments that are exceptions. However, in some embodiments, the payment transaction may not include the entire balance of the purchase transaction. Amounts may be deducted from the payment transaction as fees for the merger service, for example.

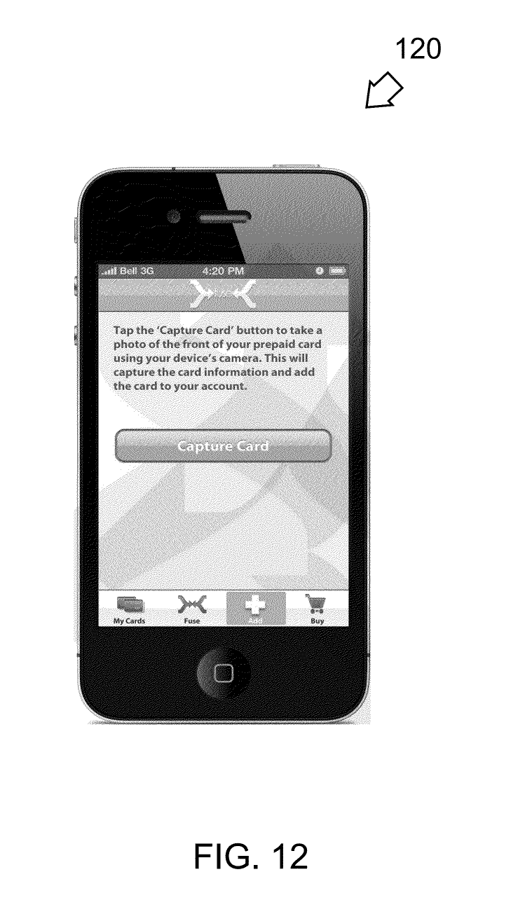

FIGS. 12-14 illustrate a mobile phone embodiment of entering payment cards 100 into a device configured to merge balances of payment cards 100, constructed and operative in accordance with an embodiment of the present disclosure. Associating payment cards to a user account may occur at registration by the user registrator 2112 or other processes known in the art. In this embodiment, a user photographs the payment card 100 with a camera that is part of mobile device 1100d. However, it is understood by those familiar with the art that other processes may be used to associate a payment card with a user, including but not limited to: text entry of a payment card Primary Account Number, swiping the payment card with a credit card reader, or Near Field Communication of a unique identifier by the payment card.

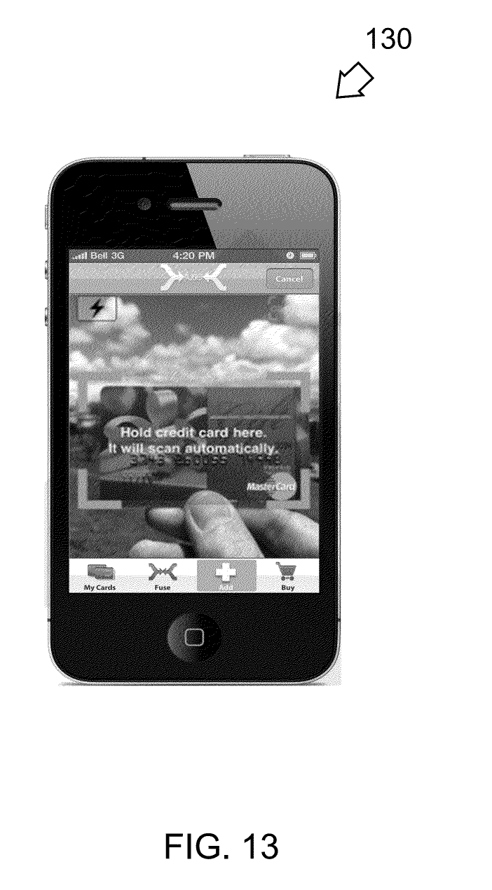

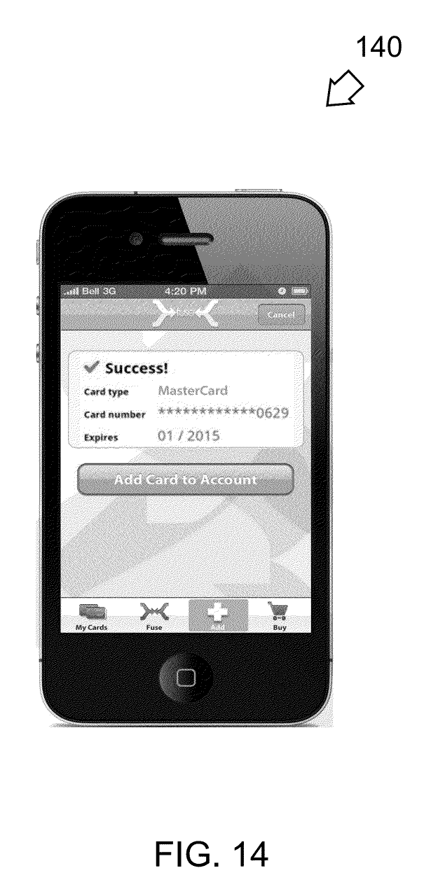

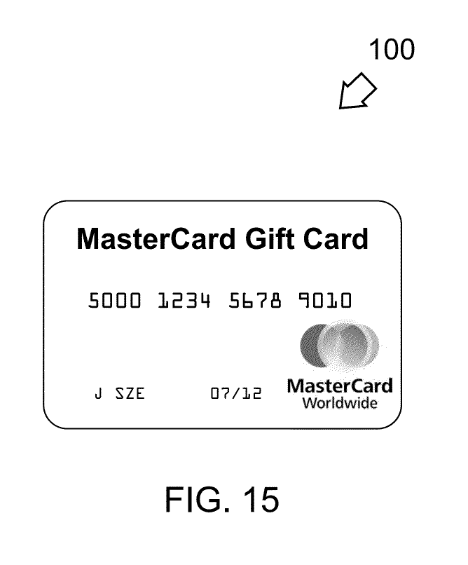

At FIG. 12, the user 1100 begins the card capture process, 120. Moving to FIG. 13, the user is prompted to hold the payment card 100 in front of the mobile device camera, 130. A photo is taken, and user registrator captures the card data in FIG. 14, 140.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A payment card service method comprising:
authenticating a user;
retrieving a plurality of payment cards associated with the user from a database;
obtaining a card balance of each of the plurality of payment cards;
presenting the plurality of payment cards and the card balances of each of the payment cards to the user;
receiving from the user, via a network interface, a selection of one of a plurality of payment cards resulting in a first selected card, and remaining cards;
receiving from the user, via the network interface, a selection of at least one of the remaining cards, resulting in a second selection of cards;
generating a purchase transaction of a purchase amount from the second selection of cards;
generating a payment transaction of a payment amount to the first selected card.

2. The payment card service method of claim 1, wherein the payment amount is less than or equal to the purchase amount.

3. The payment card service method of claim 2, wherein the card balance of each of the plurality of payment cards is obtained from a card balance service.

4. The payment card service method of claim 3, wherein a payment card fusion engine prevents a purchase transaction from a payment card associated with a charity.

5. The payment card service method of claim 4, wherein a card balance of the first selected card is not presented when the first selected card is associated with a charity.

6. The payment card service method of claim 3, wherein communication to the user is conducted via a World Wide Web interface.

7. The payment card service method of claim 3, wherein communication to the user is conducted via a mobile device.

8. The payment card service method of claim 3, wherein a fee is deducted from the payment amount.

9. A payment cards service apparatus comprising:
a network interface configured to receive from a user a selection of one of a plurality of payment cards resulting in a first selected card, and further configured to receive from the user, a selection of another one of the plurality of payment cards, resulting in a second selected card;
a processor, coupled to the network interface, configured to generate a purchase transaction with a purchase amount from the second selected card and generate a payment transaction of a payment amount to the first selected card.

10. The apparatus of claim 9, wherein the network interface is further configured to forward the payment transaction to a first issuer.

11. The apparatus of claim 10, wherein the network interface is further configured to forward the purchase transaction to a second issuer.

12. The apparatus of claim 11, wherein the payment amount is less than or equal to the purchase amount.

13. The apparatus of claim 12, wherein a card balance of each of the plurality of payment cards is obtained from a card balance service.

14. The apparatus of claim 13, wherein a payment card fusion engine prevents a purchase transaction from a payment card associated with a charity.

15. The apparatus of claim 14, wherein a card balance of the first selected card is not presented when the first selected card is associated with a charity.

16. The apparatus of claim 13, wherein communication to the user is conducted via a World Wide Web interface.

17. The apparatus of claim 13, wherein communication to the user is conducted via a mobile device.

18. The apparatus of claim 13, wherein a fee is deducted from the payment amount.

19. A method comprising:
receiving from a user, via a network interface, a selection of one of a plurality of payment cards, resulting in a first selected card;
receiving from the user, via the network interface, a selection of another one of the plurality of payment cards, resulting in a second selected card;
generating a purchase transaction in an amount from the second selected card;
generating a payment transaction of the amount to the first selected card.

20. A non-transitory computer readable medium encoded with data and instructions, when executed by a computing device the instructions causing the computing device to:
authenticate a user;
retrieve a plurality of payment cards associated with the user from a database;
obtain a card balance of each of the plurality of payment cards;
present the plurality of payment cards and the card balances of each of the payment cards to the user;
receive from the user, via a network interface, a selection of one of a plurality of payment cards resulting in a first selected card, and remaining cards;
receive from the user, via the network interface, a selection of at least one of the remaining cards, resulting in a second selection of cards;
generate a purchase transaction of a purchase amount from the second selection of cards;
generate a payment transaction of a payment amount to the first selected card.

21. The non-transitory computer readable medium of claim 20, wherein the payment amount is less than or equal to the purchase amount.

22. The non-transitory computer readable medium of claim 21, wherein the card balance of each of the plurality of payment cards is obtained from a card balance service.

23. The non-transitory computer readable medium of claim 22, wherein a payment card fusion engine prevents a purchase transaction from a payment card associated with a charity.
